(19) United States
(12) Patent Application Publication
(10) Pub. No.: US 2025/0037266 A1
(43) Pub. Date: Jan. 30, 2025

(54) OBJECT FINISH GLOSS SCORING SYSTEMS AND METHODS

(71) Applicant: LAKE COUNTRY MANUFACTURING, INC., Oconomowoc, WI (US)

(72) Inventors: Jay Derrick SCHNEIDER, Hartland, WI (US); Jacob Ray TOETZ, Milwaukee, WI (US); Lucas Adam WOLFS, Menomonee Falls, WI (US)

(21) Appl. No.: 18/713,907

(22) PCT Filed: Jan. 20, 2023
(86) PCT No.: PCT/US2023/011197

§ 371 Date: May 28, 2024

Related U.S. Application Data
(60) Provisional application No. 63/303,312, filed on Jan. 26, 2022.

(51) Int. Cl. G06T 7/00; G06T 3/40; G06T 7/13; G06T 7/41

(52) U.S. Cl. CPC G06T 7/001; G06T 3/40; G06T 7/13; G06T 7/41; G06T 2207/20021; G06T 2207/30156

(57) ABSTRACT

A gloss scoring system includes: a camera configured to capture an image of a surface of an object; a gloss score module configured to determine a gloss score value corresponding to a glossiness of the surface of the object based on: a representation of the image; stored representations of images stored in memory; and stored gloss value scores associated with the stored representations, respectively; and a display control module configured to display on a display the image and the gloss score value corresponding to the glossiness of the surface of the object.

### CROSS-REFERENCE TO RELATED APPLICATIONS

This application claims the benefit of U.S. Provisional Application No. 63/303,312 filed on 26 Jan. 2022. The entire disclosure of the application referenced above is incorporated herein by reference.

### FIELD

The present disclosure relates to finishes of/on objects, such as a vehicles, and more particularly to systems and methods for scoring glossiness of finishes of objects.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many different types of objects are painted. For example, vehicles may include multiple levels of paint. For example, one or more layers of primer may be applied to a vehicle before paint is applied to the vehicle. Once the primer has dried, one or more layers of base paint may be applied over the primer. One or more layers of clear coat may also be applied over the base paint.

Paint has different levels of gloss and sheen. Some objects, such as vehicles, may initially have glossy finishes when new. The glossiness of a finish, however, may decrease over time, such as from abrasion, particulate, wind, washing, sunlight, air, etc.

### SUMMARY

In a feature, a gloss scoring system includes: a camera configured to capture an image of a surface of an object; a gloss score module configured to determine a gloss score value corresponding to a glossiness of the surface of the object based on: (a) a representation of the image; (b) stored representations of images stored in memory; and (c) stored gloss value scores associated with the stored representations, respectively; and a display control module configured to display on a display (a) the image and (b) the gloss score value corresponding to the glossiness of the surface of the object.

In further features, the gloss score module is configured to set the gloss score value to a value within a predetermined range bounded by: a predetermined minimum score value corresponding to a minimum glossiness of surfaces; and a predetermined maximum score corresponding to a maximum glossiness of surfaces.

In further features, the gloss score module is configured to: down scale the image by a predetermined amount to produce a scaled image; and determine the representation of the image based on the scaled image.

In further features, the gloss score module is configured to: blur the scaled image to produce a blurred image; and determine the representation of the image based on the blurred image.

In further features, the gloss score module is configured to: detect edges in the blurred image; and determine the representation of the image based on the edges.

In further features, the gloss score module is configured to detect the edges in the blurred image using Canny edge detection.

In further features, the gloss score module is configured to: determine orientations of pixels, respectively, of the blurred image; determine a first histogram based on the orientations of ones of the pixels of the blurred image that include edges;

determine a second histogram based on the orientations of the ones of the pixels of the blurred image that include edges; and determine the representation of the image based on the first and second histograms.

In further features, the gloss score module is configured to: determine distances between (a) the representation of the image and (b) the stored representations, respectively; select one or more of the stored representations based on the distances; retrieve the one or more stored gloss scores value associated with the selected one or more of the stored representations, respectively; and determine the gloss score value corresponding to the glossiness of the surface of the object based on the one or more stored gloss score values associated with the selected one or more of the stored representations, respectively.

In further features, the distances are L1 distances.

In further features, the gloss score module is configured to select the one or more of the stored representations based on the distances determined based on the selected one or more of the stored representations being less than the remainder of the distances determined based on the non-selected ones of the stored representations.

In further features, the gloss score module is configured to: select two of the stored representations having the two smallest ones of the distances, respectively; and when a difference between the two smallest ones of the differences is less than a predetermined value, determine the gloss score value based on an average of the two stored gloss score values associated with the selected two of the stored representations. While the example of the two representations is provided, the present application is also more generally applicable to selecting N of the stored representations having the N smallest ones of the distances and averaging the associated N stored gloss score values, where N is an integer greater than one.

In further features, the gloss score module is configured to, when the difference between the two smallest ones of the differences is greater than the predetermined value, determine the gloss score value, corresponding to the glossiness of the surface of the object, based on one of the two stored gloss score values associated with the one of the two of the stored representations associated with the smallest one of the distances.

In further features, the gloss score module is configured to: divide the image into multiple individual images; determine individual representations for the individual images, respectively; determine individual gloss score values for the individual images, respectively, based on the individual representations and the stored representations; and determine the gloss score value corresponding to the glossiness of the surface of the object based on the individual gloss score values.

In a feature, a gloss scoring method includes: capturing an image of a surface of an object using a camera; determining a gloss score value corresponding to a glossiness of the surface of the object based on: (a) a representation of the image; (b) stored representations of images stored in memory; and (c) stored gloss value scores associated with the stored representations, respectively; and displaying on a display (a) the image and (b) the gloss score value corresponding to the glossiness of the surface of the object.

In further features, determining the gloss score value includes setting the gloss score value to a value within a predetermined range bounded by: a predetermined minimum score value corresponding to a minimum glossiness of surfaces; and a predetermined maximum score corresponding to a maximum glossiness of surfaces.

In further features, the gloss scoring method further includes: down scaling the image by a predetermined amount to produce a scaled image; and determining the representation of the image based on the scaled image.

In further features, the gloss scoring method further includes: blurring the scaled image to produce a blurred image; and determining the representation of the image based on the blurred image.

In further features, the gloss scoring method further includes: detecting edges in the blurred image; and determining the representation of the image based on the edges.

In further features, detecting the edges includes detecting the edges in the blurred image using Canny edge detection.

In further features, the gloss scoring method further includes: determining orientations of pixels, respectively, of the blurred image; determining a first histogram based on the orientations of ones of the pixels of the blurred image that include edges; determining a second histogram based on the orientations of the ones of the pixels of the blurred image that include edges; and determining the representation of the image based on the first and second histograms.

In further features, the gloss scoring method further includes: determining distances between (a) the representation of the image and (b) the stored representations, respectively; selecting one or more of the stored representations based on the distances; retrieving the one or more stored gloss scores value associated with the selected one or more of the stored representations, respectively; and determining the gloss score value corresponding to the glossiness of the surface of the object based on the one or more stored gloss score values associated with the selected one or more of the stored representations, respectively.

In further features, the distances are L1 distances.

In further features, the gloss scoring method further includes selecting the one or more of the stored representations based on the distances determined based on the selected one or more of the stored representations being less than the remainder of the distances determined based on the non-selected ones of the stored representations.

In further features, the gloss scoring method further includes: selecting two of the stored representations having the two smallest ones of the distances, respectively; and when a difference between the two smallest ones of the differences is less than a predetermined value, determining the gloss score value based on an average of the two stored gloss score values associated with the selected two of the stored representations.

In further features, the gloss scoring method further includes, when the difference between the two smallest ones of the differences is greater than the predetermined value, determining the gloss score value, corresponding to the glossiness of the surface of the object, based on one of the two stored gloss score values associated with the one of the two of the stored representations associated with the smallest one of the distances.

In further features, determining the gloss score includes: dividing the image into multiple individual images; determining individual representations for the individual images, respectively; determining individual gloss score values for the individual images, respectively, based on the individual representations and the stored representations; and determining the gloss score value corresponding to the glossiness of the surface of the object based on the individual gloss score values.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example implementation of a gloss score system;

FIG. 2 is a functional block diagram of an example implementation of a gloss score module;

FIG. 3 is a functional block diagram of an example implementation of an edge detection module;

FIG. 4 is a functional block diagram of an example implementation of a portable electronic device; and

FIG. 5 is a flowchart depicting an example method of determining and displaying a gloss score of an object.

In the drawings, reference numbers may be reused to identify similar and/or identical elements.

### DETAILED DESCRIPTION

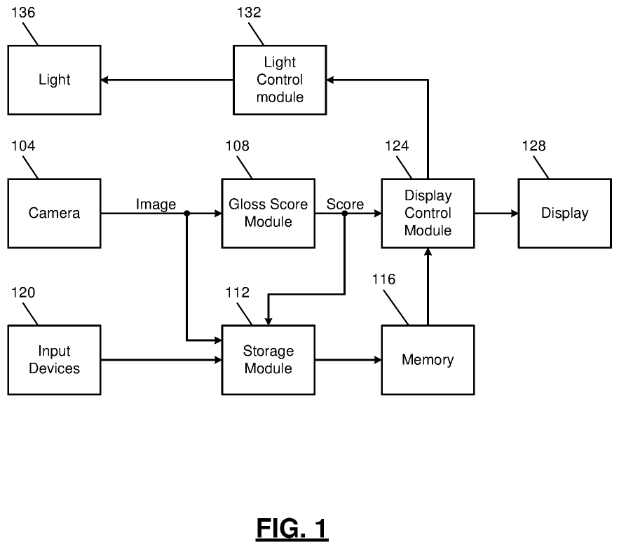

FIG. 1 is a functional block diagram of an example gloss score system. A camera 104 captures images of surfaces, such as surfaces of vehicles or another type of painted object. A gloss score module 108 determines a gloss score representative of glossiness of the paint on the object using an image. For example, the gloss score may be a value (e.g., integer or number) between 0 and 10 where 0 represents a minimum glossiness and 10 represents a maximum glossiness, and glossiness increases as the value increases and vice versa. Determination of the gloss score is discussed further below.

A storage module 112 may store the image and the gloss score for the surface in the image in memory 116. The storage module 112 may also store other information associated with the image in the memory 116. For example, the storage module 112 may store an owner's name, a make of the object, a model year, and other information regarding the object and/or the owner of the object. The storage module 112 may receive the other information via one or more input devices 120. Examples of the input devices 120 include, for example, a keyboard, which may be a virtual keyboard of a touchscreen display.

A display control module 124 controls what is displayed on a display 128. The display 128 may be, for example, a touchscreen or non-touchscreen display of a computing device. The computing device may be, for example, a smartphone, a tablet device, or another type of computing device. The display control module 124 may display, for example, the gloss score, the image, and the other information on the display 128. The computing device may include the camera 104, the gloss score module 108, the storage module 112, the memory 116, the input devices 120, the display control module, and the display 128.

In various implementations, the display control module 124 may display multiple images and multiple gloss scores on the display 128. For example, a first image of the surface may be captured by the camera 104 before polishing (to increase the glossiness of the surface). The gloss score module 108 may determine a first gloss score of the surface before the polishing based on the first image. A second image of the surface may be captured by the camera 104 after the polishing. The gloss score module 108 may determine a second gloss score of the surface after the polishing based on the second image. The display control module 124 may display the first image, the first gloss score, the second image, and the second gloss score on the display 128. This may, for example, help illustrate the benefit of the polishing. While an example is provided, multiple images and/or gloss scores may be displayed in one or more other circumstances.

In various implementations, the display control module 124 may display on the display 128 a graphical user interface (GUI) regarding capturing images, displaying captured images, displaying determined gloss scores, and other information. For capturing images, the display control module 124 may display a toggle button in the GUI for selecting either an automatic focus mode of the camera 104 and a manual focus mode of the camera 104. When the toggle button is in a first state, the camera 104 may automatically focus on one or more areas and capture an image. When the toggle button is in a second state, the camera 104 may manually focus and capture an image. The camera 104 may focus a focus distance in front of the camera 104 in response to user input (e.g., to a slider button in the GUI) to manually focus. The display control module 124 may set the state of the toggle button based on user input, such as touching of the toggle button in the GUI. The display control module 124 may set the focus based on user input, such as movement of a slider of the slider button.

For capturing images, the display control module 124 may display a toggle button in the GUI for selecting either flash or no flash operation before capturing images. When the toggle button is in a first state, a light control module 132 may turn on a light 136 before the camera 104 captures an image. When the toggle button is in a second state, the light control module 132 may leave the light 136 off for capturing images by the camera 104. The display control module 124 may set the state of the toggle button based on user input, such as touching of the toggle button in the GUI. In various implementations, the display 128 may be used as the light 136, such as when the camera 104 faces the same direction as the display 128.

For capturing images, the display control module 124 may display a toggle button in the GUI for selecting either manual or automatic temperature setting for capturing images. When the toggle button is in a first state, the camera 104 may automatically select the temperature setting. When the toggle button is in a second state, the camera 104 may user set temperature setting. The display control module 124 may set the state of the toggle button based on user input, such as touching of the toggle button in the GUI. The display control module 124 may set the temperature setting (for manual operation) based on user input, such as movement of a slider of a temperature setting slider button.

For capturing images, the display control module 124 may display a toggle button in the GUI for selecting either manual or automatic tint setting for capturing images. When the toggle button is in a first state, the camera 104 may automatically select the tint setting. When the toggle button is in a second state, the camera 104 may user set ting setting. The display control module 124 may set the state of the toggle button based on user input, such as touching of the toggle button in the GUI. The display control module 124 may set the tint setting (for manual operation) based on user input, such as movement of a slider of a tint setting slider button.

The ability to automatically or manually set focus mode, temperature setting, tint setting, and/or whether to use flash or not may increase a consistency of the images used for gloss scoring and provide users with expected options associated with capturing images.

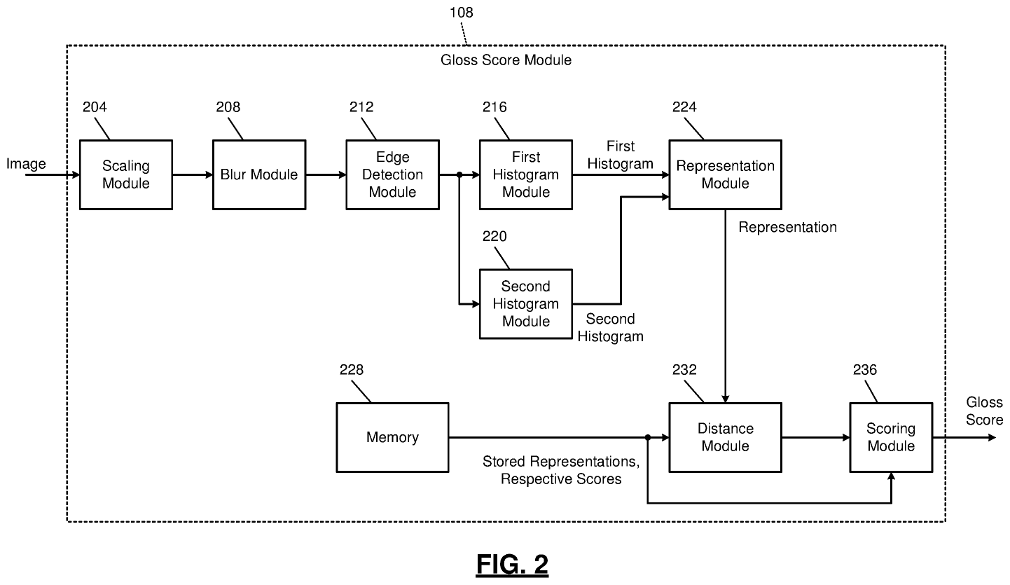

FIG. 2 is a functional block diagram of an example implementation of the gloss score module 108. The gloss score module 108 may determine a gloss score value for each image received. A scaling module 204 down scales an image to produce a scaled image. The scaling module 204 may down scale the image by a predetermined amount, such as to between 60 percent and 75 percent of the original size, or another suitable down scaling. The down scaling improves processing time and reduces image artifact noise (e.g., from camera settings, image compression, etc.).

A blur module 208 applies a blur filter to the scaled image to produce a blurred image. The blur filter may be, for example, a Gaussian blur filter. The application of the blur filter reduces image noise and may reduce a chance of a false positive being detected during edge detection.

An edge detection module 212 detects edges in the blurred image using an edge detection algorithm. The edge detection algorithm may be, for example, the Canny edge detection algorithm or another suitable type of edge detection algorithm.

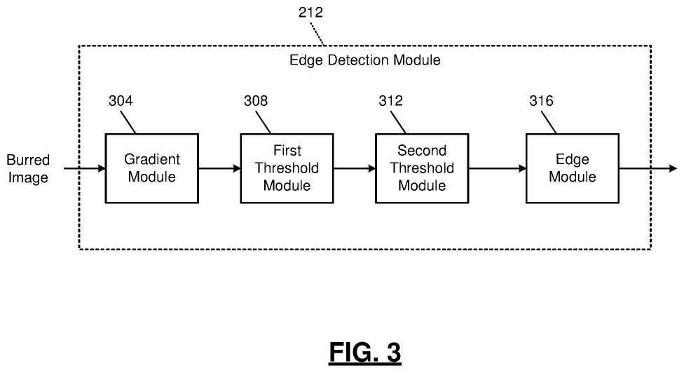

FIG. 3 is a functional block diagram of an example implementation of the edge detection module 212 utilizing the Canny edge detection algorithm. A gradient module 304 determines gradient magnitude and orientation for each pixel. The gradient of a pixel may correspond to the intensity of the pixel relative to pixels surrounding that pixel (e.g., a predetermined area centered at the pixel). The orientation of a pixel may be a degree, such as between 0 and 180, corresponding to the direction that light is changing over the pixel and the pixels surrounding (e.g., a predetermined area centered at the pixel) that pixel.

A first threshold module 308 compares the gradient (magnitude) of each pixel with gradients (edge strengths) of pixels in positive and negative gradient directions to determine whether each pixel includes an edge. The first threshold module 308 identifies a pixel as including an edge if the gradient (edge strength) of that pixel is greater than the gradients of the two pixels in the positive and negative gradient directions.

A second threshold module 312 compares the gradient of each pixel identified as including an edge by the first threshold module 308 with a first threshold value (a first predetermined value) and a second threshold value (a second threshold value). The second threshold module 312 identifies a pixel as including a strong edge when the gradient (magnitude) of the pixel is greater than or equal to the first threshold value.

The first threshold value is greater than the second threshold value. The second threshold module 312 identifies a pixel as including a weak edge when the gradient (magnitude) of the pixel is greater than or equal to the second threshold value but less than the first threshold value. The second threshold module 312 identifies a pixel as not including an edge when the gradient (magnitude) of the pixel is less than the second threshold value.

An edge module 316 determines whether each pixel includes an edge or not using an edge tracking algorithm, such as a heuristic edge tracking algorithm. Weak edges may typically be detected based on being located near or adjacent to a strong edge. The edge module 316 may identify pixels as strong edges as including an edge. For pixels identified as including a weak edge, the edge module 316 may determine whether one or more surrounding pixels (e.g., in a 3×3 square area of pixels centered at the pixel) includes a strong edge. If so, the edge module 316 identifies a pixel as including an edge. If none of the surrounding pixels includes a strong edge, the pixel is identified by the edge module 316 as not including an edge. Also, pixels identified by the second threshold module 312 as not including an edge are identified by the edge module 316 as not including an edge.

Referring to FIG. 2, a first histogram module 216 generates a first (orientation) histogram based on pixels identified as including an edge by the edge detection module 212 (e.g., the edge module 316). The first histogram module 216 iterates over the pixels including edges and bins the orientation of each pixel into one group (bin) out of multiple possible groups. Each group corresponds to a predetermined edge orientation range. For example, a first group may correspond to orientations between 0 and 10 degrees, a second group may correspond to orientations between 11 and 20 degrees, etc. The orientations may be expressed, for example, relative to a horizontal direction or a vertical direction. In various implementations, 18 possible groups may be used, where each group corresponds to a predetermined orientation range of 10 degrees.

The first histogram includes a percentage of the total number of pixels including edges within each of the groups. For example, the first histogram may be represented by {P1, P2, . . . , P18} where P1 is the percentage of the pixels including edges that are in the first group (e.g., have an orientation between 0 and 10 degrees), P2 is the percentage of the pixels including edges that are in the second group (e.g., have an orientation between 11 and 20 degrees, etc. Generally speaking, in PN, P may represent the percentage of the pixels including edges and N may be the group, where N is an integer between 1 and the total number of possible groups. The first histogram module 216 also normalizes (e.g., relative to 1) the values of the first histogram. For example, the first histogram module 216 may multiply each of the values (for the groups, respectively) by 100 such that the sum of all of the values of the histogram is equal to 100.

A second histogram module 220 generates a second (texture scale) histogram based on pixels identified as including an edge by the edge detection module 212 (e.g., the edge module 316). The second histogram module 220 iterates over the pixels that include edges. The second histogram module 220 moves (e.g., pixel by pixel) in the direction of the edge using the already determined pixel orientation until the second histogram module 220 finds another edge with a similar orientation (e.g., within a predetermined orientation range of degrees, such as +/−5 degrees). For example, the second histogram module 220 may move and find edges using Bresenham's line algorithm or another suitable algorithm. The second histogram module 220 determines the distance between the two edge pixels. The second histogram module 220 bins that pixel into a predetermined number of groups, such as 20 groups. Each group (bin) may be a percentage of a maximum distance a pixel could be from another in the image (e.g., pixel with width 600 and height 400, max length is then 721, where the first bin contains pixels that have a distance to another similar pixel between 0 and 36, the second bin would be 37-73, etc.

For example, the second histogram may be represented by {P1, P2, . . . , P20} where P1 is the percentage of the pixels including edges that are in the first group (e.g., have an orientation between 0 and 10 degrees), P2 is the percentage of the pixels including edges that are in the second group (e.g., have an orientation between 11 and 20 degrees, etc. Generally speaking, in PN, P may represent the percentage of the pixels including edges and N may be the group, where N is an integer between 1 and the total number of possible groups.

The second histogram module 220 also normalizes (e.g., relative to 1) the values of the second histogram. For example, the second histogram module 220 may multiply each of the values (for the groups, respectively) by 100 such that the sum of all of the values of the second histogram is equal to 100.

A representation module 224 generates a representation (e.g., a vector) of the image based on the first and second histograms. For example, the representation module 224 may generate the representation by concatenating the first and second histograms). The representation module 224 may also normalize the values of the representation, such as so the sum of all of the values of the representation is equal to 100.

Predetermined representations and associated gloss scores, respectively, are stored in memory. For example, one or more predetermined representations associated with a gloss score value of 1 may be stored in the memory 228, one or more predetermined representations associated with a gloss score value of 2 may be stored in the memory 228, one or more predetermined representations associated with a gloss score value of 3 may be stored in the memory 228, etc. One or more predetermined representations are stored for different possible gloss score values.

A distance module 232 determines distances between (a) the representation for the image and (b) the predetermined representations, respectively, using a predetermined distance function. The predetermined distance function may be, for example, the L1 distance function or another suitable distance function. For example, the distance module 232 determines a first distance between the representation and a first predetermined representation associated with a gloss score value of 1, a second distance between the representation and a second predetermined representation associated with a gloss score value of 2, a third distance between the representation and a third predetermined representation associated with a gloss score value of 3, etc.

A scoring module 236 determines the gloss score value for the surface in the image based on the distances and the stored scores. More specifically, the scoring module 236 selects the 2 stored predetermined representations that have the 2 smallest distances (with the representation for the image). When a difference between the distances determined for the 2 stored predetermined representations (and the representation for the image) is less than a predetermined percentage (e.g., 5 percent or another suitable value), the scoring module 236 may set the gloss score value for the surface in the image to an average (e.g., sum divided by 2) of the stored scores associated with the 2 stored predetermined representations. In this way, the gloss score value can include a whole number and a fractional part or only a whole number. When the difference between the distances determined for the 2 stored predetermined representations (and the representation for the image) is greater than the predetermined percentage, the scoring module 236 may set the gloss score value for the surface in the image to the stored score associated with the 1 of the stored predetermined representations with the smallest distance to the representation. The display control module 124 may display the image and the gloss score value determined for the image on the display 128 as discussed above.

While the example of selecting 2 stored predetermined representations is provided, the present application is applicable to storing N stored predetermined representations that have the N smallest distances, where N is an integer greater than or equal to 1.

In various implementations, the scaling module 204 may divide the scaled image (or the received image) into a predetermined number of images, such as equally sized images. For example, the scaling module 204 may divide the scaled image or the received image into 9 equally sized images (e.g., divide the image into a 3 wide×3 high grid of images). The above may be performed on each of the (e.g., 9) individual images to determine a gloss score value for each of the individual images. The scoring module 236 may determine the gloss score value for the surface in the image based on the gloss score values for the individual images, such as using an equation or a lookup table. For example only, the scoring module 236 may determine the gloss score value for the surface in the image based on or equal to an average of the individual gloss score values (e.g., sum the individual gloss score values and divided by the total number of individual gloss score values/images). In various implementations, one or more of the images resulting from the division may be excluded from the gloss score value determination. For example, one or more images including glare may be excluded.

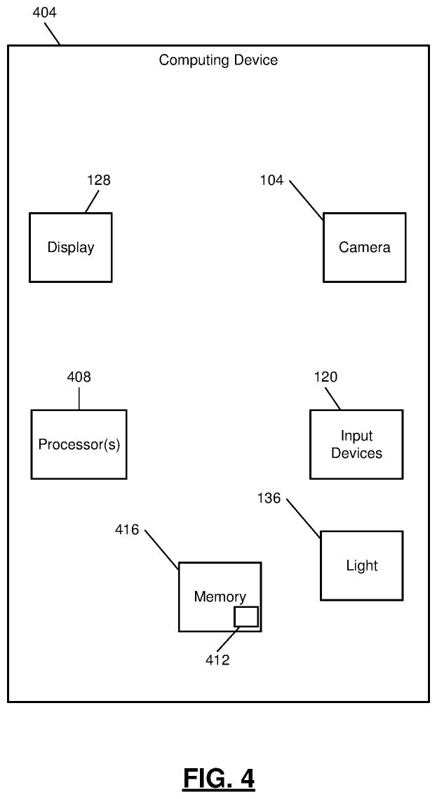

FIG. 4 is a functional block diagram of an example computing device 404, such as smartphone, a tablet computing device, a wearable computing device (e.g., a smart watch, smart glasses, etc.), or another suitable type of computing device. In various implementations, the functionality discussed above may be implemented by one or more processors 408 executing an application 412 stored in memory 416. The application 412 may be configured to, when executed by the processor(s) 408, determine gloss score values and generate displays, as discussed above.

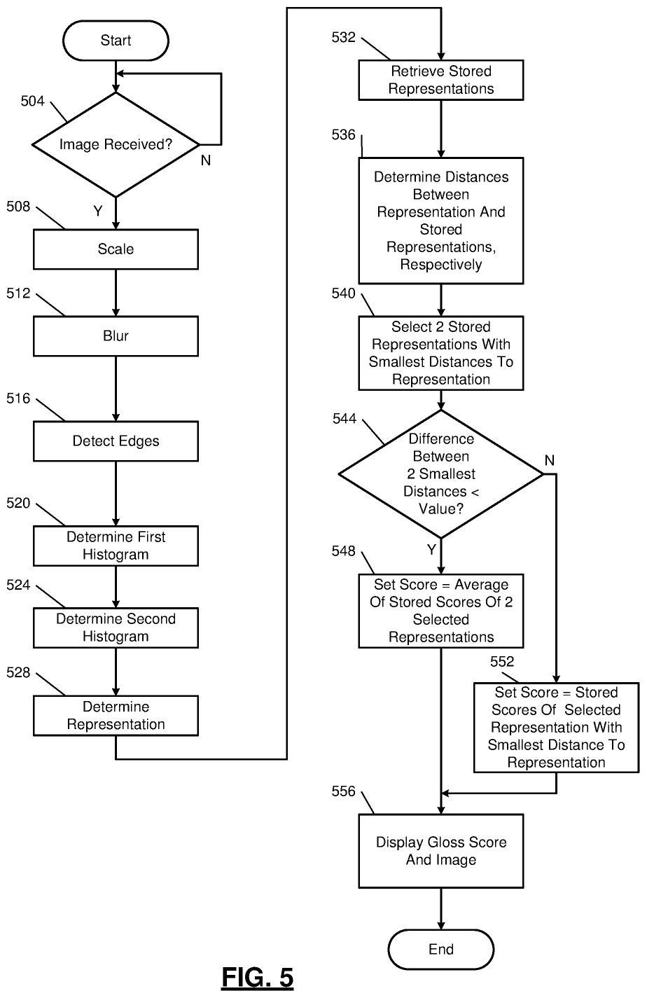

FIG. 5 is a flowchart depicting an example method of determining and displaying a gloss score value representative of glossiness of a surface of an object in an image. Control begins with 504, such as while the processor(s) 408 are executing the application 412. At 504, the gloss score module 108 determines whether an image has been received. If 504 is true, control continues with 508. If 504 is false, control may remain at 504. Focus of the image may be manual or automatic. Tint and/or temperature of the image may be set automatically or manually. Whether to turn on the light 136 to capture the image may be set manually.

At 508, the scaling module 204 down scales the image and produces the scaled image. At 512, the blur module 208 blurs the scaled image and produces the blurred image. At 516, the edge detection module 212 detects edges in the blurred image as discussed above.

At 520, the first histogram module 216 determines the first histogram for the image based on the pixels of the image determined to include edges. At 524, the second histogram module 220 determines the second histogram for the image based on the pixels of the image determined to include edges. At 528, the representation module 224 generates the representation of the image based on the first and second histograms, such as by concatenating the first and second histograms.

At 532, the distance module 232 retrieves the stored predetermined representations (having respective associated gloss score values) from the memory 228. At 536, the distance module 232 determines the distances (e.g., L1 distances) between the stored predetermined representations, respectively, and the representation of the image.

At 540, the scoring module 236 selects the 2 stored predetermined representations with the lowest (smallest) distances to the representation of the image. The scoring module 236 determines a difference between the distances associated with the 2 stored predetermined representations and the representation of the image.

At 544, the scoring module 236 determines whether the difference between the distances is less than a predetermined value, such as 5 percent or another suitable value. If 544 is true, the scoring module 236 sets the gloss score value for the surface in the image to an average of the 2 stored scores for the 2 stored predetermined representations, respectively, at 548. The scoring module 236 may set the average, for example, based on or equal to the sum of the 2 stored scores divided by 2. If 544 is false, the scoring module 236 sets the gloss score value for the surface in the image to the stored score of the one of the stored predetermined representations with the smallest distance to the representation of the image at 552. While the example of the two representations is provided, the present application is also more generally applicable to selecting N of the stored representations having the N smallest ones of the distances and averaging the associated N stored gloss score values, where N is an integer greater than one.

At 556, the display control module 124 displays the gloss score value and the image on the display 128. The display control module 124 may also display one or more other gloss score values, one or more other images, and/or other information on the display 128. One or more other actions may also be taken based on or including the gloss score value. While control is shown as ending, control may return to 504 for a next image.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A gloss scoring system comprising:
a camera configured to capture an image of a surface of an object;
a gloss score module configured to determine a gloss score value corresponding to a glossiness of the surface of the object based on:
(a) a representation of the image;
(b) stored representations of images stored in memory; and
(c) stored gloss value scores associated with the stored representations, respectively; and
a display control module configured to display on a display (a) the image and (b) the gloss score value corresponding to the glossiness of the surface of the object.

2. The gloss scoring system of claim 1 wherein the gloss score module is configured to set the gloss score value to a value within a predetermined range bounded by:
a predetermined minimum score value corresponding to a minimum glossiness of surfaces; and
a predetermined maximum score corresponding to a maximum glossiness of surfaces.

3. The gloss scoring system of claim 1 wherein the gloss score module is configured to:
down scale the image by a predetermined amount to produce a scaled image; and
determine the representation of the image based on the scaled image.

4. The gloss scoring system of claim 3 wherein the gloss score module is configured to:
blur the scaled image to produce a blurred image; and
determine the representation of the image based on the blurred image.

5. The gloss scoring system of claim 4 wherein the gloss score module is configured to:
detect edges in the blurred image; and
determine the representation of the image based on the edges.

6. The gloss scoring system of claim 5 wherein the gloss score module is configured to detect the edges in the blurred image using Canny edge detection.

7. The gloss scoring system of claim 5 wherein the gloss score module is configured to:
determine orientations of pixels, respectively, of the blurred image;
determine a first histogram based on the orientations of ones of the pixels of the blurred image that include edges;
determine a second histogram based on the orientations of the ones of the pixels of the blurred image that include edges; and
determine the representation of the image based on the first and second histograms.

8. The gloss scoring system of claim 1 wherein the gloss score module is configured to:
determine distances between (a) the representation of the image and (b) the stored representations, respectively;
select one or more of the stored representations based on the distances;
retrieve the one or more stored gloss scores value associated with the selected one or more of the stored representations, respectively; and
determine the gloss score value corresponding to the glossiness of the surface of the object based on the one or more stored gloss score values associated with the selected one or more of the stored representations, respectively.

9. The gloss scoring system of claim 8 wherein the distances are L1 distances.

10. The gloss scoring system of claim 8 wherein the gloss score module is configured to select the one or more of the stored representations based on the distances determined based on the selected one or more of the stored representations being less than the remainder of the distances determined based on the non-selected ones of the stored representations.

11. The gloss scoring system of claim 8 wherein the gloss score module is configured to:
select two of the stored representations having the two smallest ones of the distances, respectively; and
when a difference between the two smallest ones of the differences is less than a predetermined value, determine the gloss score value based on an average of the two stored gloss score values associated with the selected two of the stored representations.

12. The gloss scoring system of claim 11 wherein the gloss score module is configured to, when the difference between the two smallest ones of the differences is greater than the predetermined value, determine the gloss score value, corresponding to the glossiness of the surface of the object, based on one of the two stored gloss score values associated with the one of the two of the stored representations associated with the smallest one of the distances.

13. The gloss scoring system of claim 1 wherein the gloss score module is configured to:
divide the image into multiple individual images;
determine individual representations for the individual images, respectively;
determine individual gloss score values for the individual images, respectively, based on the individual representations and the stored representations; and
determine the gloss score value corresponding to the glossiness of the surface of the object based on the individual gloss score values.

14. A gloss scoring method, comprising:
capturing an image of a surface of an object using a camera;
determining a gloss score value corresponding to a glossiness of the surface of the object based on:
(a) a representation of the image;
(b) stored representations of images stored in memory; and
(c) stored gloss value scores associated with the stored representations, respectively; and
displaying on a display (a) the image and (b) the gloss score value corresponding to the glossiness of the surface of the object.

15. The gloss scoring method of claim 14 wherein determining the gloss score value includes setting the gloss score value to a value within a predetermined range bounded by:
a predetermined minimum score value corresponding to a minimum glossiness of surfaces; and
a predetermined maximum score corresponding to a maximum glossiness of surfaces.

16. The gloss scoring method of claim 14 further comprising:
down scaling the image by a predetermined amount to produce a scaled image; and
determining the representation of the image based on the scaled image.

17. The gloss scoring method of claim 16 further comprising:
blurring the scaled image to produce a blurred image; and
determining the representation of the image based on the blurred image.

18. The gloss scoring method of claim 17 further comprising:
detecting edges in the blurred image; and
determining the representation of the image based on the edges.

19. The gloss scoring method of claim 18 wherein detecting the edges includes detecting the edges in the blurred image using Canny edge detection.

20. The gloss scoring method of claim 18 further comprising:
determining orientations of pixels, respectively, of the blurred image;
determining a first histogram based on the orientations of ones of the pixels of the blurred image that include edges;
determining a second histogram based on the orientations of the ones of the pixels of the blurred image that include edges; and
determining the representation of the image based on the first and second histograms.

21. The gloss scoring method of claim 14 further comprising:
determining distances between (a) the representation of the image and (b) the stored representations, respectively;
selecting one or more of the stored representations based on the distances;
retrieving the one or more stored gloss scores value associated with the selected one or more of the stored representations, respectively; and
determining the gloss score value corresponding to the glossiness of the surface of the object based on the one or more stored gloss score values associated with the selected one or more of the stored representations, respectively.

22. The gloss scoring method of claim 21 wherein the distances are L1 distances.

23. The gloss scoring method of claim 21 further comprising selecting the one or more of the stored representations based on the distances determined based on the selected one or more of the stored representations being less than the remainder of the distances determined based on the non-selected ones of the stored representations.

24. The gloss scoring method of claim 21 further comprising:
selecting two of the stored representations having the two smallest ones of the distances, respectively; and
when a difference between the two smallest ones of the differences is less than a predetermined value, determining the gloss score value based on an average of the two stored gloss score values associated with the selected two of the stored representations.

25. The gloss scoring method of claim 24 further comprising, when the difference between the two smallest ones of the differences is greater than the predetermined value, determining the gloss score value, corresponding to the glossiness of the surface of the object, based on one of the two stored gloss score values associated with the one of the two of the stored representations associated with the smallest one of the distances.

26. The gloss scoring method of claim 14 wherein determining the gloss score includes:
dividing the image into multiple individual images;
determining individual representations for the individual images, respectively;
determining individual gloss score values for the individual images, respectively, based on the individual representations and the stored representations; and
determining the gloss score value corresponding to the glossiness of the surface of the object based on the individual gloss score values.
